(19) United States
(12) Patent Application Publication
(10) Pub. No.: US 2026/0034655 A1
(43) Pub. Date: Feb. 5, 2026

(54) Hand-held power tool and method for operating a hand-held power tool

(71) Applicant: Hilti Aktiengesellschaft, Schaan (LI)

(72) Inventors: Steffen Geiger, Muenchen (DE); Christian Augustin, Poettmes (DE); Darko Saric, Graefelfing (DE); Markus Rank, Buchloe (DE); Stefan SCHMID, Untermuehlhausen (DE); Christian IGLHAUT, Duenzelbach (DE)

(21) Appl. No.: 19/351,686

(22) Filed: Oct. 7, 2025

Related U.S. Application Data
(63) Continuation of application No. 17/269,676, now abandoned.

(30) Foreign Application Priority Data
Sep. 20, 2018 (EP) 18195633.5

(51) Int. Cl. B25D 17/04

(52) U.S. Cl. CPC B25D 17/043; B25D 2250/095; B25D 2250/121; B25D 2250/201; B25D 2250/221

(57) ABSTRACT

The hand-held power tool (1) includes a housing (8), which has a first housing element (9) and a second housing element (10), wherein the first housing element (9) and the second housing element (10) are decoupled from one another and are movable relative to one another. The hand-held power tool (1) furthermore includes a tool holder (2) and a motor (4) for rotational and/or percussive driving of the tool holder (2). Furthermore, the hand-held power tool (1) has a magnetic field sensor (16) for detecting a spacing (L) between the first housing element (9) and the second housing element (10). Moreover, the hand-held power tool (1) includes a control device (18) for setting a motor speed of the motor (4) in accordance with the detected spacing (L).

This is a Continuation of U.S. Ser. No. 17/269,676, filed on Feb. 19, 2021, now published as US 2021/0339372 A1, which is a National Stage application of PCT/EP2019/074052, filed on Sep. 10, 2019, claiming priority to European Patent application EP 18195633.5, filed on Sep. 20, 2018, all of which are hereby incorporated by reference herein.

### FIELD OF THE INVENTION

The present invention relates to a hand-held power tool and to a method for operating a hand-held power tool.

### BACKGROUND

In the case of hand-held power tools, the application and engagement of a tool of the hand-held power tool, for example of a drill bit, to/on a workpiece is often problematic. This is the case especially with hand-held power tools that have a high single impact energy and/or a low dead weight. EP 1 466 702 A1 discloses a hand-held electric power tool having a force sensor for measuring a pressing force of the hand-held electric power tool against a workpiece. EP 1 958 735 A1 discloses a hand-held power tool having a base housing and an outer housing, which is held on the base housing via decoupling means and is firmly connected to a main handle and side handle connection means. EP 1 882 559 A1 discloses a hand-held power tool having a housing and a handle, which is held on the housing via a decoupling arrangement.

### SUMMARY OF THE INVENTION

It is an object of the present invention to provide an improved hand-held power tool and to improve a method for operating a hand-held power tool.

According to a first aspect, the present invention provides a hand-held power tool comprising a housing, which has a first housing element and a second housing element. The first housing element and the second housing element are decoupled from one another and movable relative to one another. The hand-held power tool furthermore comprises a tool holder and a motor for rotational and/or percussive driving of the tool holder. Furthermore, the hand-held power tool comprises a magnetic field sensor for detecting a spacing between the first housing element and the second housing element. Moreover, the hand-held power tool comprises a control device for setting a motor speed of the motor in accordance with the detected spacing.

The hand-held power tool is for example a hammer drill, a chisel hammer, a combination hammer, a core drill or a screwdriver. The tool holder of the hand-held power tool is used to insert a rotatable tool, for example a drill bit or a chisel tool. The motor of the hand-held power tool is in particular an electric motor. The motor of the hand-held power tool is in particular a motor with an adjustable speed. The motor of the hand-held power tool is used in particular to set the tool in a rotary motion and/or a striking motion by rotational and/or percussive driving of the tool holder. For example, the motor of the hand-held power tool is used to set the tool in rotation about a working axis by rotationally driving the tool holder around the working axis. By rotating the tool, a workpiece, such as a base material and/or a wall, can be drilled. For example, the motor of the hand-held power tool is also used to set the tool in a striking motion in a direction of impact by percussively driving the tool holder in the direction of impact. The direction of impact is in particular parallel to the working axis. An object can be chiseled by the striking motion of the tool.

Owing to the work on a workpiece with the rotating and/or percussive tool of the hand-held power tool, a reaction force may act on a handle of the hand-held power tool. For example, a reaction torque may act on the handle owing to the rotational work on a workpiece. In particular, vibrational movements may be imparted to the handle by the rotational and/or percussive work on a workpiece.

To damp or avoid vibrational movements of the handle, the housing of the hand-held power tool has two housing elements, namely the first housing element and the second housing element, which are mechanically decoupled from one another. In particular, the tool holder is arranged on the first housing element, and the second housing element has the handle of the hand-held power tool. By virtue of the mechanical decoupling of the first housing element from the second housing element, a reaction force from the tool and the tool holder is not transmitted or is transmitted only to a limited extent to the handle.

In particular, the first housing element and the second housing element are secured movably on one another and mechanically decoupled from one another with the aid of a decoupling means. In particular, the decoupling means holds the first housing element and the second housing element apart. The decoupling means is, in particular, compressible, with the result that the spacing between the first housing element and the second housing element can be changed by compressing the decoupling means. In particular, there is a variable spacing between the first housing element and the second housing element by virtue of the decoupling means. The decoupling means has one or more spring elements, bearings and/or sprung bearings, for example.

To work on a workpiece, a user holding the hand-held power tool by the handle exerts a force on the handle in the direction of the workpiece. The spacing between the first housing element, on which the tool holder with the tool is arranged, and the second housing element, which comprises the handle, is reduced by a pressing force of the user. In particular, the pressing force compresses the decoupling means. The harder the user presses against the handle, the smaller the spacing between the first housing element and the second housing element becomes.

To detect the variable spacing between the first housing element and the second housing element, the hand-held power tool has the magnetic field sensor. The magnetic field sensor is for example a Hall sensor, a magneto-resistive sensor or a field plate sensor. The magnetic field sensor is preferably a one-dimensional magnetic field sensor, e.g. a linear Hall sensor, or a multi-dimensional magnetic field sensor, e.g. a 3D magnetic field sensor and/or 3D Hall sensor. However, other magnetic field sensors can also be used in the hand-held power tool.

The magnetic field sensor is arranged on the first housing element and measures the spacing with respect to the second housing element, or it is arranged on the second housing element and measures the spacing with respect to the first housing element.

By virtue of the fact that the hand-held power tool has the magnetic field sensor for detecting the spacing between the first housing element and the second housing element, the pressing force which the user is applying to the hand-held power tool via the handle can be determined.

The control device of the hand-held power tool for setting the motor speed of the motor in accordance with the detected spacing serves, in particular, to increase the motor speed when the detected spacing decreases. For example, the control device is designed to increase the motor speed in a ramp-like manner when the detected spacing decreases. For example, the control device is designed to increase the motor speed in inverse proportion to the detected spacing. For example, the control device is designed to increase the motor speed linearly in accordance with the reciprocal of the detected spacing.

Through the setting of the motor speed in accordance with the detected spacing, it is also possible, in particular, for the rotary mode of the tool holder to be set in accordance with the detected spacing. For example, a rotation rate and/or a torque of the tool holder can be set in accordance with the detected spacing, and/or a rotary motion of the tool holder can be started in accordance with the detected spacing. Through the setting of the motor speed in accordance with the detected spacing, it is also possible, in particular, for the percussive mode of the tool holder to be set in accordance with the detected spacing. For example, an impact frequency, impact amplitude and/or impact force of the tool holder can be set in accordance with the detected spacing, and/or a striking motion of the tool holder can be started in accordance with the detected spacing. In particular, the setting of the motor speed in accordance with the detected spacing can comprise starting the percussive driving of the tool holder in accordance with the detected spacing.

Since the detected spacing between the first housing element and the second housing element is a measure of the pressing force of the user, the control device can set the hand-held power tool in accordance with the pressing force applied by the user. In particular, the control device is designed to increase the motor speed if the pressing force determined increases. As a result, the user can intuitively control the power output of the hand-held power tool via the pressing force.

The pressing-force-dependent setting of the hand-held power tool makes it possible, for example, for the hand-held power tool to be applied to the workpiece more easily and for the process of working on the workpiece to be begun more easily and in an improved manner. This is possible, in particular, also for hand-held power tools with a low dead weight.

For example, the tool can be applied to a workpiece at a low motor speed, and the motor speed can then be increased in a ramp-like manner up to a maximum speed. It is thereby possible, for example, to apply a hammer drill to the workpiece without a striking motion and to initiate the striking motion only by pressure against the workpiece.

According to one embodiment, the control device is designed to determine a pressing force from the detected spacing and to set the motor speed of the motor in accordance with the pressing force determined.

For example, the control device calculates the pressing force from the detected spacing with the aid of an algorithm in the control device.

The control device is designed, in particular, to increase the motor speed in accordance with the pressing force determined. For example, the control device is designed to increase the motor speed in a ramp-like manner if the pressing force determined increases. For example, the control device is designed to increase the motor speed in proportion to the pressing force determined. For example, the control device is designed to increase the motor speed linearly in accordance with the pressing force determined.

Through the setting of the motor speed in accordance with the pressing force determined, it is also possible, in particular, for the rotary mode of the tool holder to be set in accordance with the pressing force determined. For example, the rotation rate and/or the torque of the tool holder can be set in accordance with the pressing force determined, and/or the rotary motion of the tool holder can be started in accordance with the pressing force determined. Through the setting of the motor speed in accordance with the pressing force determined, it is also possible, in particular, for the percussive mode of the tool holder to be set in accordance with the pressing force determined. For example, an impact frequency, impact amplitude and/or impact force of the tool holder can be set in accordance with the pressing force determined, and/or a striking motion of the tool holder can be started in accordance with the pressing force determined. In particular, the setting of the motor speed in accordance with the pressing force determined, that is to say also in accordance with the detected spacing, can comprise starting the percussive driving of the tool holder in accordance with the pressing force determined.

It is thereby possible, for example, to avoid a troublesome striking motion of the tool in the idling mode. The idling mode is a mode in which the motor rotates but no work is performed on a workpiece. Upon each new application of the hand-held power tool, it is furthermore possible for a gentle run-up of the hand-held power tool, controlled intuitively by the user via the pressing force, to be achieved.

According to another embodiment, the control device is designed to increase the motor speed of the motor in accordance with the pressing force determined if the pressing force determined is greater than a first particular threshold value.

The first particular threshold value corresponds to a particular pressing force. In particular, the first particular threshold value corresponds to a particular pressing force which indicates application of the tool to a workpiece. In particular, the control device compares the pressing force determined with the first particular threshold value. If the control device determines that the pressing force determined is greater than the first particular threshold value, the control device increases the motor speed continuously as the pressing force rises and in direct proportion to the pressing force determined, for example.

By virtue of the fact that the control device is designed to increase the motor speed of the motor in accordance with the pressing force determined if the pressing force determined is greater than the first particular threshold value, it is possible to determine that the tool has been applied reliably to a workpiece since a minimum pressure corresponding to the first particular threshold value is being exerted on the workpiece. Moreover, it is thereby possible to ensure that the hand-held power tool responds dynamically to the pressing force of the user. In particular, this enables the tool applied to the workpiece to remain in reliable contact with the workpiece during further work. In particular, it is possible to avoid the tool slipping off the workpiece due to the drilling and/or percussive mode.

According to another embodiment, the control device is designed to set the motor speed of the motor to a maximum motor speed if the pressing force determined is greater than a second particular threshold value. The second particular threshold value is greater than the first particular threshold value.

The second particular threshold value corresponds to a particular pressing force which, in particular, indicates that the tool is reliably engaging on the workpiece. In particular, the control device compares the pressing force determined with the second particular threshold value. If the control device determines that the pressing force determined is greater than the second particular threshold value, it sets the motor speed to the maximum motor speed. The maximum motor speed is a maximum motor speed for which the motor of the hand-held power tool is designed, for example.

By virtue of the fact that the control device is designed to set the motor speed of the motor to the maximum motor speed if the pressing force determined is greater than the second particular threshold value, the maximum power of the hand-held power tool is available as soon as it is detected that the tool is engaging reliably on the workpiece. At a corresponding pressing force, the maximum power can be available 250 milliseconds after the first application to the workpiece, for example.

According to another embodiment, a magnet is arranged on the first housing element, and the magnetic field sensor is arranged on the second housing element. Moreover, the magnetic field sensor is designed to detect a spacing between the magnetic field sensor and the magnet as the spacing between the first housing element and the second housing element.

The magnet is a permanent magnet or comprises a coil, for example. In particular, the magnetic field sensor arranged on the second housing element comprising the handle measures a magnetic field of the magnet arranged on the first housing element. The magnetic field detected at the location of the magnetic field sensor is dependent on the spacing from the magnet, and therefore the magnetic field sensor can detect the spacing between the magnetic field sensor and the magnet.

By virtue of the fact that the magnetic field sensor is arranged on the second housing element, which is preferably decoupled from the vibrational movements of the first housing element, the magnetic field sensor can be protected from vibrations.

By virtue of the fact that the magnet is arranged on the first housing element, the magnetic field sensor is arranged on the second housing element, and the magnetic field sensor detects the spacing between the magnetic field sensor and the magnet, the spacing between the first housing element and the second housing element can be accurately detected. As a result, the pressing force can be determined very accurately.

According to another embodiment, the magnetic field sensor is a 3D magnetic field sensor.

The 3D magnetic field sensor is a magnetic field sensor which can detect a magnetic field in three spatial directions. In particular, a 3D magnetic field sensor measures a three-dimensional vector of the magnetic flux density of the magnetic field. The 3D magnetic field sensor is, for example, a 3D Hall sensor, in which one or more Hall-effect elements per spatial direction are arranged on a chip.

By virtue of the fact that the magnetic field sensor is a 3D magnetic field sensor, the magnetic field of the magnet arranged on the first housing element can be determined very accurately, for example. In particular, by virtue of the fact that the magnetic field sensor is a 3D magnetic field sensor, the spacing between the first housing element and the second housing element can be determined very accurately. A finely calibrated response of the power output of the motor to the spacing and thus the pressing force is thereby possible.

According to another embodiment, the tool holder is arranged on the first housing element, and the second housing element has a handle of the hand-held power tool.

As a result, the tool holder can be decoupled from the handle by means of the decoupling of the first housing element from the second housing element. As a result, vibrations of the handle due to reaction forces of the tool and of the tool holder can be attenuated or avoided.

In particular, the motor, the striking mechanism and the drive shaft are also arranged in the first housing element in this embodiment.

According to another embodiment, the first housing element is arranged at least partially within the second housing element.

In particular, the tool holder is arranged on the inner first housing element, and the outer second housing element has the handle of the hand-held power tool in this embodiment.

As a result, the decoupling of the handle from the tool holder to reduce vibrations can be implemented by means of a sub-chassis solution.

In embodiments, the first housing element can also be arranged adjacent to the second housing element instead of at least partially within the second housing element.

According to another embodiment, the control device is designed to set the motor speed of the motor in accordance with the detected spacing by open-loop control of the motor speed in accordance with the detected spacing or by closed-loop control of the motor speed in accordance with the detected spacing.

According to a second aspect, the present invention provides a method for operating a hand-held power tool. The hand-held power tool has a motor for rotational and/or percussive driving of a tool holder and has a magnetic field sensor. Moreover, the hand-held power tool has a housing having a first housing element and a second housing element. The first housing element and the second housing element are decoupled from one another and movable relative to one another. The method has a step of detecting a spacing between the first housing element and the second housing element by means of the magnetic field sensor. Moreover, the method has a step of setting a motor speed of the motor in accordance with the detected spacing.

Properties and advantages that have been described for the hand-held power tool apply correspondingly to the proposed method for operating the hand-held power tool.

According to one embodiment of the second aspect, the method has a step of determining a pressing force from the detected spacing.

The determination of the pressing force from the detected spacing is carried out by the control device described in connection with the hand-held power tool, for example.

The step of determining the pressing force from the detected spacing takes place, in particular, after the step of detecting the spacing between the first housing element and the second housing element and before the step of setting the motor speed of the motor in accordance with the detected spacing. In particular, the method steps mentioned are carried out repeatedly in the sequence mentioned during operation of the hand-held power tool.

The step of setting the motor speed of the motor in accordance with the detected spacing comprises, in particular, setting the motor speed of the motor in accordance with the pressing force determined.

According to another embodiment of the second aspect, the setting of the motor speed of the motor in accordance with the detected spacing comprises open-loop control of the motor speed in accordance with the detected spacing or closed-loop control of the motor speed in accordance with the detected spacing.

According to another embodiment of the second aspect, the setting of the motor speed of the motor comprises increasing the motor speed in accordance with the pressing force determined if the pressing force determined is greater than a first particular threshold value.

According to another embodiment of the second aspect, the setting of the motor speed of the motor comprises setting the motor speed to a maximum motor speed if the pressing force determined is greater than a second particular threshold value. The second particular threshold value is greater than the first particular threshold value.

The control device has for example a processor and a computer program that can be executed with the aid of the processor. The control device, for example the computer program, comprises, in particular, an algorithm or a plurality of algorithms, which is/are designed to determine the pressing force from the detected spacing, to compare the pressing force determined with the first particular threshold value and the second particular threshold value, and/or to set the motor speed.

The respective unit, for example the processor, can be implemented in terms of hardware and/or also in terms of software. In a hardware implementation, the unit can be formed as a device or as part of a device, for example as a computer or as a microprocessor. In a software implementation, the unit can be formed as a computer program product, as a function, as a routine, as part of a program code or as an executable object.

A computer program product, such as for example a computer program means, can be provided or supplied, for example, as a storage medium, such as for example a memory card, USB stick, CD-ROM, DVD, or in the form of a downloadable file from a server in a network. This can be done for example in a wireless communication network by transmitting a corresponding file with the computer program product or the computer program means.

The embodiments and features described for the method apply correspondingly to the hand-held power tool and vice versa.

### BRIEF DESCRIPTION OF THE FIGURES

The following description explains the invention with reference to exemplary embodiments and figures. In the figures:

FIG. 1 shows a schematic view of a hand-held power tool; and

FIG. 2 shows a schematic view of a method for operating the hand-held power tool according to FIG. 1.

### DETAILED DESCRIPTION

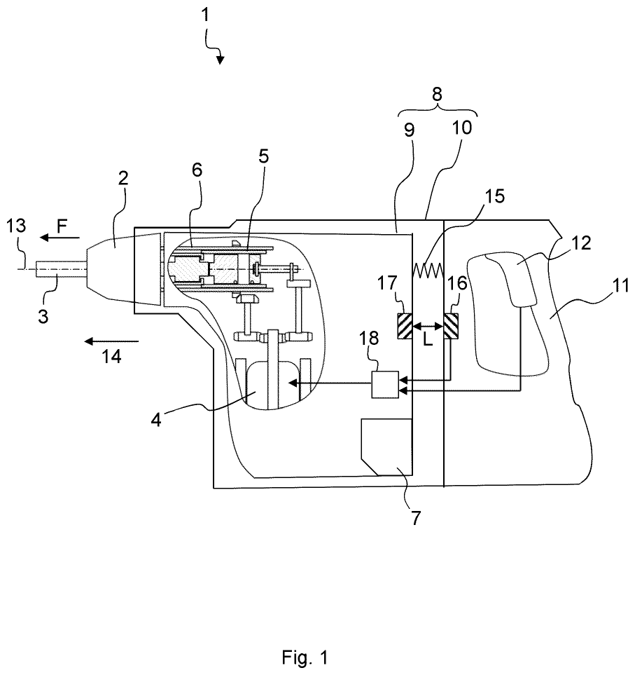

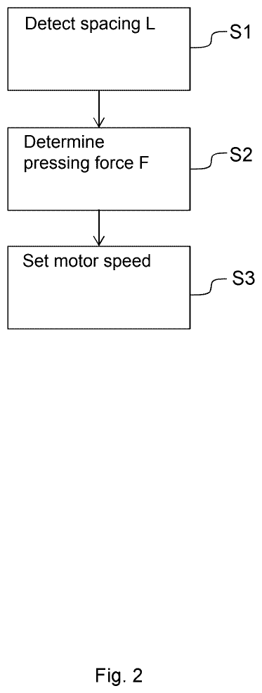

An embodiment of hand-held power tool 1 and a method for operating the hand-held power tool 1 are described below with reference to FIGS. 1 and 2.

FIG. 1 shows a hammer drill as an exemplary embodiment of the hand-held power tool 1. The hammer drill 1 has a tool holder 2, in which a shaft end of a tool 3, for example a drill bit or a chiseling tool, can be inserted. A motor 4, which drives a striking mechanism 5 and a drive shaft 6, forms a primary drive of the hammer drill 1. A rechargeable battery 7 or a power cord (not shown) supplies the motor 4 with power.

The hammer drill 1 has a housing 8, which comprises a first housing element 9 and a second housing element 10. The second housing element 10 has a handle 11, by which a user can hold and guide the hammer drill 1. The user can put the hammer drill 1 into operation by means of a main button 12. Owing to the actuation of the main button 12, the motor 4 rotates at an adjustable motor speed, the motor 4 drives the drive shaft 6, and the drive shaft 6 imparts a rotary motion to the tool holder 2 about a working axis 13. As a result, the tool 3 is rotated about the working axis 13. During operation, in addition to the rotation about the working axis 13, the hammer drill 1 can strike the tool 3 into a base material in a direction of impact 14 along the working axis 13. Because the striking mechanism 5 drives the tool holder 2, in addition to the rotary motion about the working axis 13, the tool 3 performs striking motions in the direction of impact 14. In an exemplary embodiment, the hammer drill 1 has a mode selector switch (not shown), by means of which the tool holder 2 can be decoupled from the drive shaft 6, so that a purely chiseling mode of the hammer drill 1 is possible.

The first housing element 9 and the second housing element 10 of the hammer drill 1 are decoupled mechanically from one another by decoupling means 15. The tool holder 2, the motor 4, the striking mechanism 5, the drive shaft 6 and the rechargeable battery 7 are arranged on the first housing element 9. The second housing element 10 comprises the handle 11. In the case of a drilling and/or percussive mode of the hammer drill 1, reaction forces of the tool 3 and of the tool holder 2 can lead to vibration of the first housing element 9. By virtue of the decoupling of the first housing element 9 from the second housing element 10 by means of the decoupling means 15, this vibration of the first housing element 9 is not transmitted, or transmitted only in attenuated form, to the handle 11. In the embodiment shown in FIG. 1, the decoupling is achieved by arrangement of the first housing element 9 within the second housing element 10. In another embodiment (not shown), the decoupling of the first housing element 9 from the second housing element 10 can instead be achieved by arrangement of the second housing element 10 with the handle 11 adjacent to the first housing element 9.

There is a variable spacing L between the first housing element 9 and the second housing element 10. In the state of rest, i.e. without the user pressing the hammer drill 1 against a workpiece, the spacing L is predetermined by the decoupling means 15.

The user who wishes to work on a workpiece with the hammer drill 1 holds the hammer drill 1 by the decoupled handle 11 and puts the hammer drill 1 into operation by actuating the main button 12. By actuation of the main button 12, the motor 4 is first of all set in a rotary motion at a low motor speed. The tool 3 is furthermore set in a rotary motion about the working axis 13. The user applies the tool 3 of the hammer drill 1 to the workpiece. To work on the workpiece and start the percussive mode, the user exerts a pressing force F on the handle 11. This pressing force F is aligned substantially in the direction of the workpiece, i.e. along the working axis 13.

The variable spacing L between the first housing element 9 and the second housing element 10 is reduced by the pressing force F of the user. In particular, the pressing force F compresses the decoupling means 15. The harder the user presses against the handle 11, the smaller the spacing L between the first housing element 9 and the second housing element 10 becomes.

FIG. 2 shows a schematic view of a method for operating the hammer drill 1 from FIG. 1.

In a first step S1 of the method, the spacing L between the first housing element 9 and the second housing element 10 is detected by means of the magnetic field sensor 16.

To detect the spacing L between the first housing element 9 and the second housing element 10, the hammer drill 1 has the magnet 17 in addition to the magnetic field sensor 16. The magnetic field sensor 16 is arranged on the second housing element 10. The magnet 17 is arranged on the first housing element 9. The magnetic field sensor 16 detects the magnetic field of the magnet 17, in particular the magnetic flux density of the magnet 17. The greater the pressing force F of the user against the handle 11, the smaller is the spacing L between the first housing element 9 and the second housing element 10, in particular between the magnetic field sensor 16 and the magnet 17. The smaller the spacing L between the magnetic field sensor 16 and the magnet 17, the greater is the magnetic field detected by the magnetic field sensor 16. Consequently, the magnetic field sensor 16 can detect the spacing L by detecting the magnetic field of the magnet 17. The magnetic field sensor 16 transmits the spacing L as a signal to a control device 18 of the hammer drill 1.

In a second step S2 of the method, the pressing force F is determined from the detected spacing L. In particular, the control device 18 determines the pressing force F from the detected spacing L by a calculation with the aid of an algorithm in the control device 18.

In a third step S3 of the method, the motor speed of the motor 4 is set in accordance with the detected spacing L, in particular in accordance with the pressing force F determined.

In particular, the control device 18 is designed to increase the motor speed of the motor 4 in accordance with the pressing force F determined if the pressing force F determined is greater than a first particular threshold value. For this purpose, the control device 18 compares the pressing force F determined in the second step S2 of the method with the first particular threshold value. The first particular threshold value is a particular pressing force which indicates reliable application of the tool 3 to the workpiece.

If the control device 18 determines that the pressing force F determined is greater than the first particular threshold value and, consequently, the tool 3 has been reliably applied to the workpiece, the control device 18 sends a signal to the motor 4 to increase the motor speed. In particular, the control device 18 sends a signal to the motor 4 to increase the motor speed of the motor 4 continuously and in direct proportion to the pressing force F determined as the pressing force rises. Owing to the increase in the motor speed, the percussive mode of the tool holder 2 starts. By the further increase in the motor speed, an impact frequency, impact amplitude and/or impact force are continuously increased. By virtue of the fact that the motor speed is first of all increased and the percussive mode starts only when the first particular threshold value is exceeded, the tool can be applied more easily to the workpiece.

Moreover, the control device 18 is designed to set the motor speed of the motor 4 to a maximum motor speed if the pressing force F determined is greater than a second particular threshold value, wherein the second particular threshold value is greater than the first particular threshold value. For this purpose, the control device 18 compares the pressing force F determined with the second particular threshold value. The second particular threshold value corresponds to a particular pressing force which, in particular, indicates that the tool 3 is reliably engaging on the workpiece.

If the control device 18 determines that the pressing force F determined is greater than the second particular threshold value, that is to say as soon as the tool reliably engages on the workpiece, the control device 18 sets the motor speed to the maximum motor speed for which the motor 4 is designed. The maximum power of the hammer drill 1 is thus available.

With the hammer drill 1 described and the method described for operating the hammer drill 1, the user can work safely and in an intuitive manner on a workpiece with the tool 3 of the hammer drill 1 by means of a pressing-force-controlled gentle run-up of the hammer drill 1 and a subsequent pressing-force-controlled maximum power output of the hammer drill 1.

### LIST OF REFERENCE SIGNS

1 Hand-held power tool (hammer drill)
2 Tool holder
3 Tool
4 Motor
5 Striking mechanism
6 Drive shaft
7 Rechargeable battery
8 Housing
9 First housing element
10 Second housing element
11 Handle
12 Main button
13 Working axis
14 Direction of impact
15 Decoupling means
16 Magnetic field sensor
17 Magnet
18 Control device
S1 Method step
S2 Method step
S3 Method step

What is claimed is:

1. A hand-held power tool comprising:
a housing having a first housing element and a second housing element, the first housing element and the second housing element being vibrationally decoupled from one another and movable relative to one another;
a tool holder;
a motor for rotational or percussive driving of the tool holder;
a magnetic field sensor for detecting a spacing between the first housing element and the second housing element; and
a controller for setting a motor speed of the motor in accordance with the detected variable spacing, the controller configured to determine a pressing force from the detected spacing and to set a motor speed of the motor in accordance with the pressing force determined, and to increase the motor speed linearly in accordance with the pressing force when rising or continuously and in direct proportion to the pressing force determined.

2. The hand-held power tool as recited in claim 1 wherein the controller is designed to increase the motor speed of the motor in accordance with the pressing force determined if the pressing force determined is greater than a first particular threshold value.

3. The hand-held power tool as recited in claim 2 wherein the controller is designed to set the motor speed of the motor to a maximum motor speed if the pressing force determined is greater than a second particular threshold value, wherein the second particular threshold value is greater than the first particular threshold value.

4. The hand-held power tool as recited in claim 1 wherein the magnetic field sensor is a 3D magnetic field sensor.

5. The hand-held power tool as recited in claim 1 wherein the tool holder is arranged on the first housing element, and the second housing element has a handle of the hand-held power tool.

6. The hand-held power tool as recited in claim 1 wherein the first housing element is arranged at least partially within the second housing element.

7. The hand-held power tool as recited in claim 1 wherein the controller is designed to set the motor speed of the motor in accordance with the detected variable spacing by closed-loop control of the motor speed in accordance with the detected variable spacing.

8. The hand-held power tool as recited in claim 1 wherein the controller is designed to set the motor speed of the motor in accordance with the detected variable spacing by open-loop control of the motor speed in accordance with the detected variable spacing.

9. A method for operating a hand-held power tool having a motor for rotational or percussive driving of a tool holder, a magnetic field sensor, a single magnet and a housing having a first housing element and a second housing element, wherein the first housing element and the second housing element are vibrationally decoupled from one another and are movable relative to one another, the method comprising the following steps:
detecting a spacing between the first housing element and the second housing element via the magnetic field sensor;
determining a pressing force from the detected spacing; and
setting a motor speed of the motor in accordance with the pressing force determined, and increasing the motor speed linearly in accordance with the pressing force when rising or continuously and in direct proportion to the pressing force determined.

10. The method as recited in claim 9 wherein the setting of the motor speed of the motor in accordance with the detected variable spacing includes open-loop control of the motor speed in accordance with the detected variable spacing.

11. The method as recited in claim 9 wherein the setting of the motor speed of the motor in accordance with the detected variable spacing includes closed-loop control of the motor speed in accordance with the detected variable spacing.

12. The method as recited in claim 9 wherein the setting of the motor speed of the motor includes increasing the motor speed in accordance with the pressing force determined if the pressing force determined is greater than a first particular threshold value.

13. The method as recited in claim 12 wherein the setting of the motor speed of the motor includes setting the motor speed to a maximum motor speed if the pressing force determined is greater than a second particular threshold value, wherein the second particular threshold value is greater than the first particular threshold value.

14. The hand-held power tool as recited in claim 1 further comprising a magnet arranged on the first housing element, and the magnetic field sensor arranged on the second housing element, and the magnetic field sensor designed to detect a spacing between the magnetic field sensor and the magnet as the spacing between the first housing element and the second housing element.
